(19) United States
(12) Patent Application Publication
(10) Pub. No.: US 2004/0075824 A1
(43) Pub. Date: Apr. 22, 2004

(54) Optical flow monitor

(76) Inventors: Mikhail Belenkii, San Diego, CA (US); Chris Sexton, San Diego, CA (US)

Correspondence Address: JOHN R. ROSS, TREX ENTERPRISES, 10455 PACIFIC CENTER CT., SAN DIEGO, CA, 92121, US

(21) Appl. No.: 10/685,244

(22) Filed: Oct. 14, 2003

Related U.S. Application Data
(63) Continuation-in-part of application No. 10/155,094, filed on May 23, 2002, now Pat. No. 6,683,679.

(51) Int. Cl. G01P 3/36

(52) U.S. Cl. 356/28; 356/28.5

(57) ABSTRACT

A flow monitor that is purely optical and non-invasive and does not possess any significant obstruction to the flow. It creates no significant pressure drop and no pulsed pressure waves in the patient's airway and can be placed close to the patient, it is not sensitive to gas composition and contamination, it is easy to clean, because it uses a disposable or reusable flow measurement cuvette, and it is more accurate, rugged and reliable than existing sensors on the market. Fluid flow is determined by optically monitoring the time of travel of a disturbance in the fluid flow. In one embodiment, the disturbance is caused by heating the fluid and in another embodiment, the disturbance in air flow is caused by injecting minute drops of water into the flowing air.

This application is a continuation-in-part of Ser. No. 10/155,094 filed May 23, 2002. This invention relates to flow measurement and monitoring devices and in particular to optical flow monitoring devices.

### BACKGROUND OF THE INVENTION

Accurate measurement and monitoring of fluid flow is important in many situations. One important application of fluid flow monitoring devices is the monitoring of respirator gas flow. Respiratory circuits are typically composed of flexible tubing with an inside diameter of 15 mm. The flow is bi-directional and peaks as high as 20 liters per minute. The gas mixture in the circuits typically contains N₂, O₂, CO₂, N₂O, with vapor ethanol, anesthetic and other drugs in varying concentrations. The concentration of all gases including O₂ varies from the inspired part of the cycle to the expired portion of the cycle. However, at least 21% O₂ is always present in the gas mixture in the circuit, and it generally has much higher concentrations of O₂. The CO₂ concentration is approximately zero on the inspired part of the cycle and as high as 10% on the expired portion of the cycle. Other gases may or may not be present in varying concentrations. For most patients relative humidity of the respirator air is maintained in the range of about 30-70%. Existing flow measuring products on the market include hot wire anemometer, fine mesh net, and pressure drop sensors. All of these products have as a principal shortcoming that they position an obstruction to the flow that creates a pressure drop in the flow channel. Cleaning of these devices is difficult. Ultrasonic anemometers are also known. Their principal shortcomings are that there are sensitive to gas composition and contaminations. Also, they are difficult to clean because they do not allow the use of a disposable or reusable flow measurement cuvette. Finally, they create pulsed pressure waves in the flow channel, and therefore cannot be placed close to the patient. Optical devices for measuring fluid flow are known. These include laser Doppler anemometers. These devices are expensive and they require seeding the flow with calibrated particles. In addition, they position obstruction in the flow channel.

What is needed is a very reliable and accurate, non-invasive, gas-independent, easy to clean, low cost and portable fluid flow measuring and monitoring device, which can be placed close to the patient.

### SUMMARY OF THE INVENTION

The present invention provides a flow monitor that is purely optical and non-invasive and does not possess any significant obstruction to the flow. It creates no significant pressure drop and no pulsed pressure waves in the patient's airway and can be placed close to the patient, it is not sensitive to gas composition and contamination, it is easy to clean, because it uses a disposable or reusable flow measurement cuvette, and it is more accurate, rugged and reliable than existing sensors on the market. Fluid flow is determined by optically monitoring the time of travel of a disturbance in the fluid flow. In one embodiment, the disturbance is caused by heating the fluid and in another embodiment, the disturbance in air flow is caused by injecting minute drops of water into the flowing air. In the first embodiment, fluid flow is determined by correlating two interference signals produced by coherent laser beams passing through a flowing fluid at two spaced-apart paths. The distance between the two paths is known and the correlation of the two signals is used to determine the time required for the fluid to flow between the two paths. In a preferred embodiment actually built and tested by Applicant the correlation is made by having an operator monitor on an oscilloscope the intensities of interference fringes corresponding to each of the two beam paths. Intensity variations in the interference fringes are caused by the same turbulent eddies passing each of the two paths. These turbulent eddies cause fluctuations in the index of refraction of the fluid which produce similar patterns on the oscilloscope which are separated on the oscilloscope time scale by an amount corresponding to the distance between the two beam paths and the flow rate of the fluid. The operator can determine the time difference between the similar patterns in the two beams and knowing the actual distance between the beams the operator can calculate the flow rate. In preferred embodiments the interference signals are produced using shear plates. In one preferred embodiment useful for monitoring the flow rate of a respirator, the correlation of the fringe intensity values corresponding to the two beam paths is made by a digital computer programmed with an algorithm for making cross correlation analyses that utilizes a Fast Fourier Transform (FFT) algorithm. The invention is based on measurements of the flow of turbulent inhomogeneities in the fluid flow at two locations with a known separation. In preferred embodiments the turbulent inhomogeneities of the flow are increased by heating the fluid just upstream of the two beam paths. The flow velocity is estimated from the measured travel time, which is required for the flow to move turbulent eddies from one location to another, and the known separation between the two locations.

### BRIEF DESCRIPTION OF THE DRAWINGS

FIG. 1 is a drawing of a preferred embodiment of the present invention.

FIG. 1A shows how spectral fringes are produce with a shear plate.

FIGS. 2A, 2B and 2C are copies of oscilloscope traces showing actual fringe intensity signals and demonstrating the ease of correlating the fringe data to determine flow rates.

FIGS. 3A and 3B are oscilloscope traces showing inhale and exhale traces showing the two-way accuracy of the present invention.

FIG. 4 shows a calibration of the present invention against a mechanical flow device.

FIG. 5 shows a block diagram and basic equation for making a cross-correlation of two sets of spectral interference fringe data to determine flow rate.

FIG. 6 shows how a preferred flow monitor fits into a respirator tube.

FIG. 7 shows a technique for practicing the present invention by using separate portions of a single laser beam to monitor fluid flow.

FIG. 8 present charts explaining a technique for measuring flow using two different methods.

FIG. 9 is a drawing showing features of a water droplet embodiment.

FIG. 10 shows a path of water droplets in air flow.

FIG. 11 shows how to deal with two-direction flow.

FIG. 12 shows test results of the FIG. 11 type embodiment.

### DETAILED DESCRIPTION OF PREFERRED EMBODIMENTS

### First Preferred Embodiment

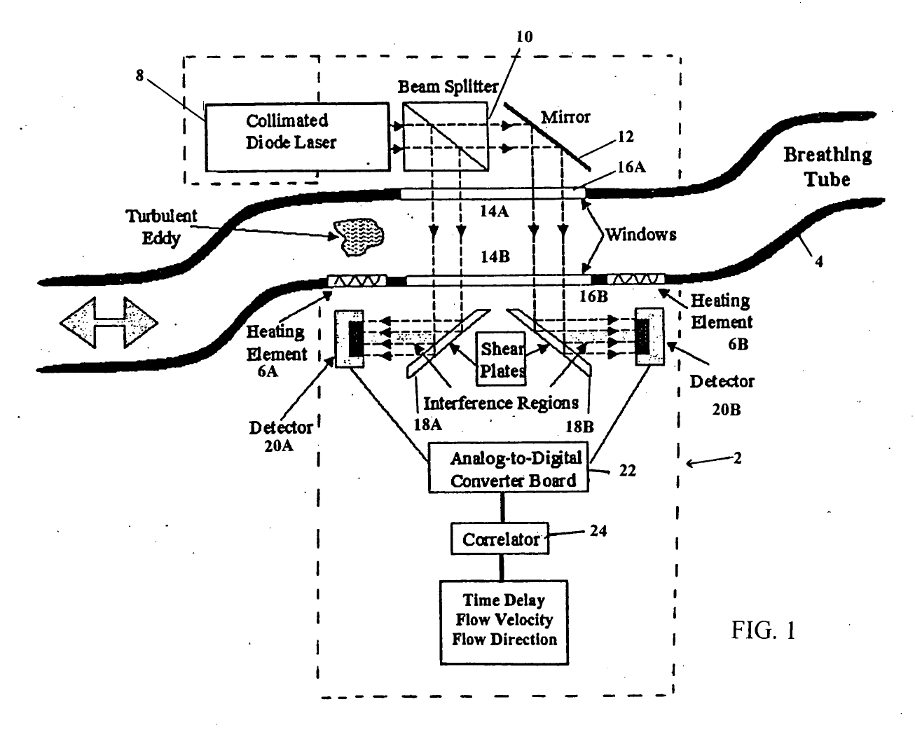

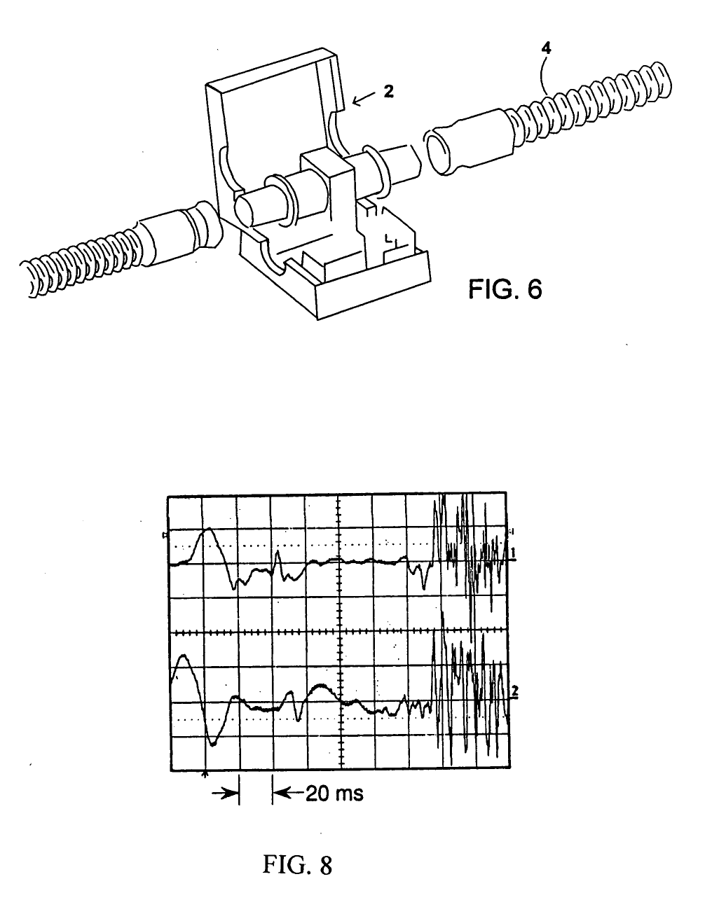

A first preferred embodiment of the present invention is shown in FIG. 1. An optical respirator flow monitor 2 represented by components within the dashed lines in FIG. 1 is substituted for a section of respirator breathing tube 4 as shown also in FIG. 6. Heating elements 6A and 6B are located on the patient side and the respirator side of the optical portion of the monitor. Diode laser system 8 produces a collimated coherent laser beam at a wavelength of 633 nm. Beam splitter 10 and mirror 12 separate the single beam from the laser system into two beams 14A and 14B both of which pass through windows 16A and 16B and the flowing fluid the flow rate of which is to be monitored. Interference fringes are produced in both beams 14A and 14B by shear plates 18A and 18B as shown in FIG. 1A. Detectors 20A and 20B are photodiode detectors and each are positioned to monitor the spectral intensity of a single selected interference fringe as shown in FIG. 1B. The spatial separation of beams 14A and 14B is precisely measured. An analog-to-digital converter board 22 converts both sets of signals to digital and these signals are correlated by digital processor 24 to determine the time difference between similar fringe intensity patterns and from these time difference values and the known spatial separation of the two beams the respirator flow and direction is determined. In this preferred embodiment Applicant used a single mode diode laser: 5 mW, 633 nm wavelength, 8 mm beam diameter, available from Power Tech. Inc., Part Number: PM(LD1212)TC5. The detectors each were a silicon photodiode: SiPIN, 1 mm diameter, 1 ns response time, available from Thorlabs Inc., Part Number: FDS010. The receiver aperture diameter was 1 mm. FIG. 1A is a sketch showing how shear plate 18A produces fringe patterns 26. Detector 20A is positioned to monitor only the peak intensity of only one of these fringes such as fringe 26A as shown in FIG. 1B.

### Oscilloscope Data

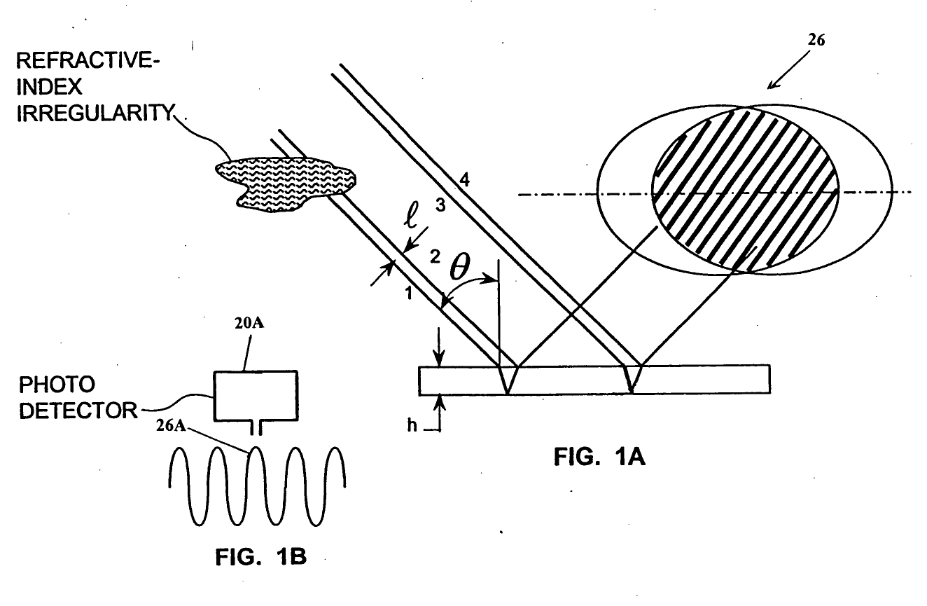

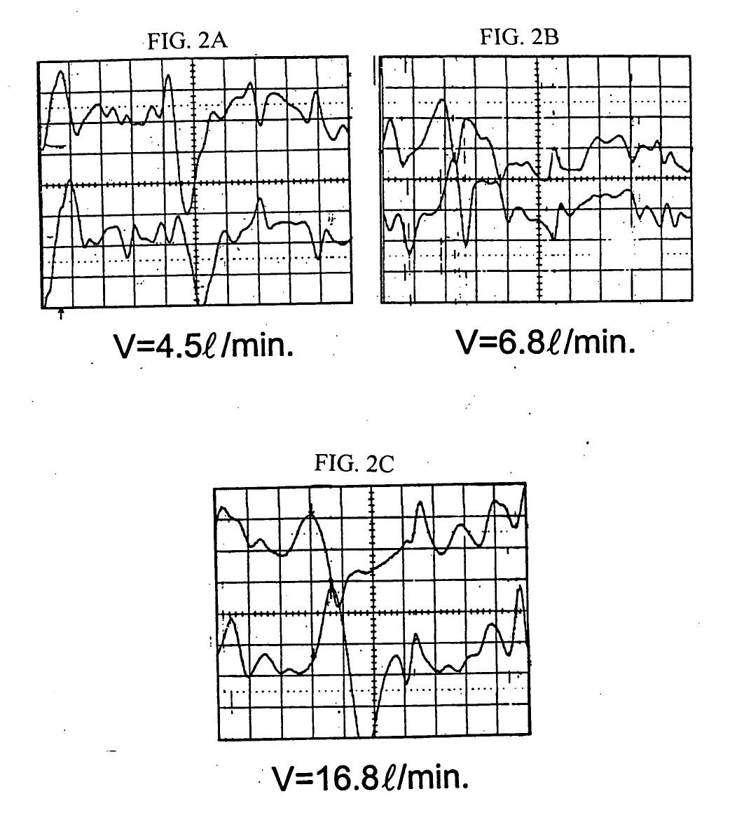

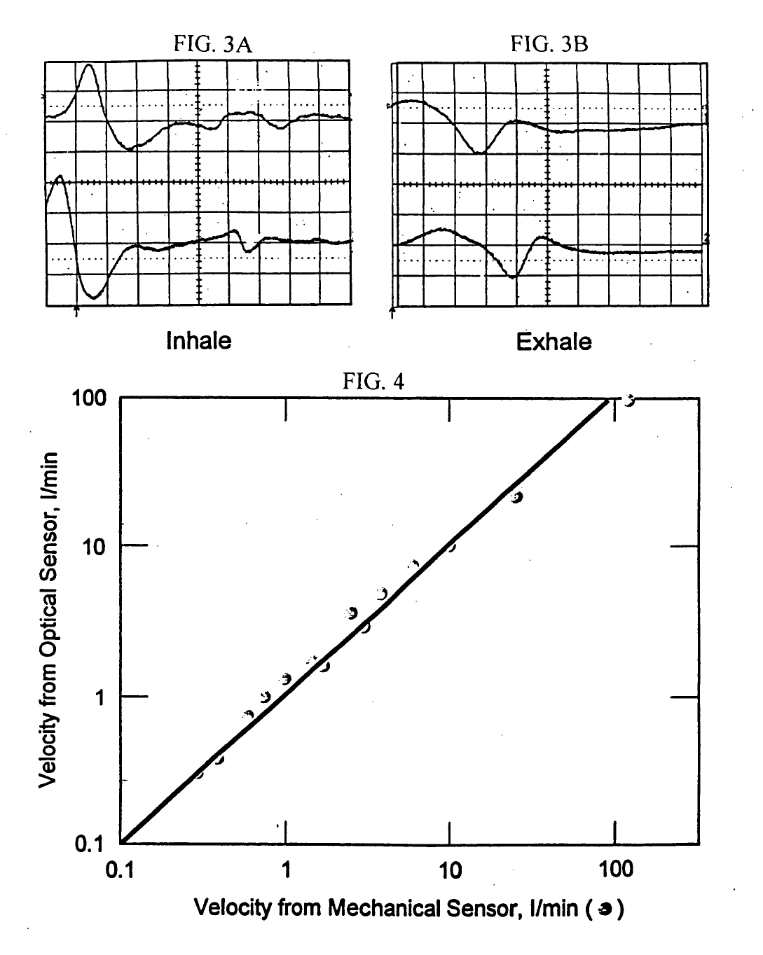

Applicant has proven the effectiveness of the present invention by monitoring the output signals of detectors 20A and 20B with an oscilloscope. Typical traces are shown in FIGS. 2A, 2B and 2C. These charts show traces with respirator flow at 4.5 l/min, 6.8 l/min and 16.8 l/min. In these cases the correlations between the similar patterns are obvious and the flow rates can be confirmed manually by an operator. FIGS. 3A and 3B show similar traces with a comparison between inhale and exhale to prove that this invention works equally well for flow in either direction. FIG. 4 is a chart, which compares test results from the present invention with a prior art mechanical sensor showing that the flow measurements correlate in the range from less than one litter/min to more than 100 litters/min.

### Cross-Correlations

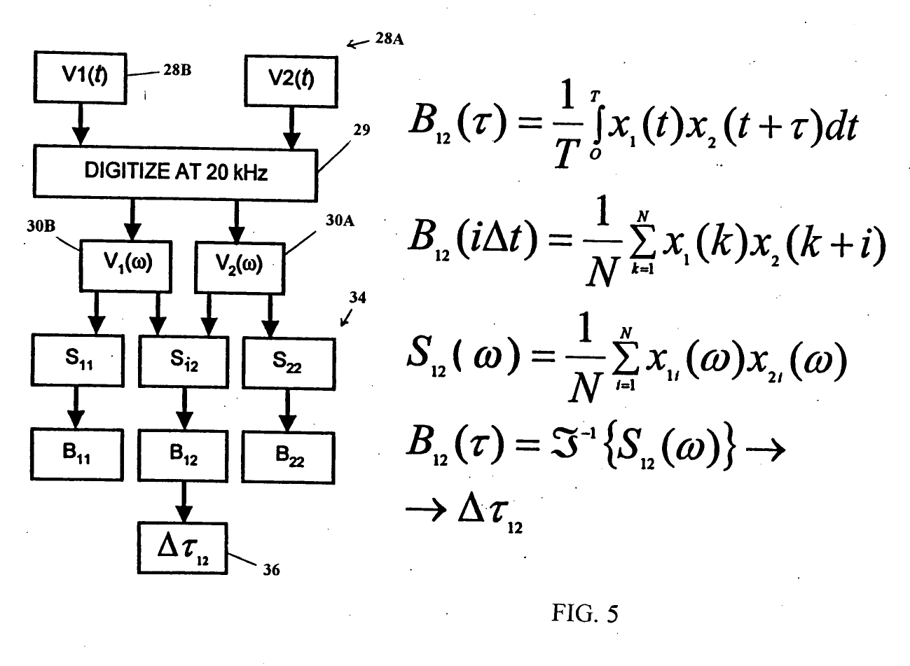

FIG. 5 shows a preferred technique for making the correlations automatically with a digital computer. The two analog signals V1(t) and V2(t) as shown at 28A and 28B are digitized as shown at 29 in FIG. 5 with A to D converter board 22. The signals are then converted to frequency signals V1(ω) and V2(ω) using a FFT algorithm as shown at 30A and 30B. Then the auto spectra S₁₁ and S₂₂ are computed and the signals are correlated to compute the cross-spectrum S₁₂ as shown at 32. An inverse Fourier transform is then performed on the cross-spectrum as shown at 34 and the time delay Δt of the peak of the cross-correlation is determined as shown at 36. The processor then calculates and displays the respirator flow rate as r/At, where r is the distance between two detectors.

### Cross-Spectra

Flow direction and flow velocity is determined by calculating the phase spectrum and coherence spectrum of the intensities of the interference fringes caused by the same turbulent inhomogeneities passing each of the two paths. The flow direction is determined by the sign of the phase delay between intensity values in two measurement channels and the flow velocity is determined from the ratio

$$v = \frac{2 π fr}{θ} ,$$

where r is the distance between two detectors,

$$f = \frac{2 π}{ω}$$

is the frequency, and θ is the phase spectrum of the intensity values in two measurement channels. The cross-spectrum of the signals acquired with two spaced detectors is a Fourier transform of the cross-correlation function

$${S}_{12} ( r , f ) = \frac{1}{2 π} {\int }_{- ∞}^{∞} {B}_{12} ( r , τ ) exp [ - i2 π f τ ] ⅆ τ$$

where r is the distance between two detectors, f is the frequency, B₁₂ (r,τ) is the time-lagged cross-correlation function. The cross-spectrum is the complex value

S₁₂(r,f)=γ(r,f)exp[−iθ(r,f)]

where γ(r, f) is the modulus called the coherence spectrum, and θ(r, f) is the phase spectrum. The phase spectrum determines the phase delay between two signals and relates to the flow velocity V by equation

$$θ ( r , f ) = \frac{2 π f}{V}$$

Therefore, the flow velocity is given by

$$V = \frac{2 π f}{θ ( r , f )} .$$

### Zero Crossing Points Method

The physical meaning of this equation is the following. Let us select in the moving pattern of optical turbulent disturbances a Fourier component with a spatial period Λ. If this component is moved with flow velocity V, then at two locations separated at distance r the frequency component with temporal frequency f=ΛV will have a phase shift of θ=2πfΔt, where Δt=r/V. Therefore, the flow velocity is determined by

$$V = \frac{2 π f r }{θ} .$$

The flow direction may be determined by calculating the cumulative difference between the values of the positive part of the cross-correlation function to the negative part thereof, whereby the direction of the flow is defined by the sign of the result of calculation and flow velocity is determined by computing for each of said signals the number of zero crossing points. The number of times the instantaneous signal cross the average signal in each detector using a proper calibration function is converted to the flow velocity. Since the number of zero crossing is a measure of the temporal spectrum of the measured signal, which is proportional to the flow rate, it is clear that the flow rate can be estimated by using the zero crossing points method. This method has an advantage that it is insensitive to evolution of optical disturbances between two spaced locations.

For more details concerning preferred cross-correlation and cross-spectral techniques, the reader is referred to one of the following texts:

1. Bendat J. and Piersol A., Engineering applications of correlation and spectral analysis. NY. Willey, 1980, and 1993 (2nd addition).

2. Bendat J. and Piersol A., Random data: Analysis and measurement procedures. NY. Willey, 1974.

3. Jenkins G. and Watts D. Spectral analysis and its application, 1969.

4. Jackson, L. B. Digital Filters and Signal Processing. Third Ed. Boston: Kluwer Academic Publishers, 1989.

5. Kay, S. M. Modern Spectral Estimation. Englewood Cliffs, N.J.: Prentice Hall, 1988.

6. Oppenheim, A. V., and R. W. Schafer. Discrete-Time Signal Processing. Englewood Cliffs, N.J.: Prentice Hall, 1989.

In summary preferred techniques for making these cross correlations is as follows:

1) Detect the intensity of the laser beam with two detectors, separated at the distance equal to the width of the interference fringes and positioned at the peaks of the neighboring fringes.

2) Process the analog output signal of each detector by amplifying its signal, converting the analog signal to digital and inputting the digital signal into a computer processor.

3) Calculating the average and normalized signal values for each detector to produce a time series for each detector,

4) Calculating the normalized time-lagged cross-correlation function between intensity values for the two time series, and

5) Determine the time delay of the peak of the normalized time-lagged cross correlation function between intensity values measured with the two detectors. The direction of the flow is determined by the sign of the time delay and the flow velocity is determined by the ratio of the separation between the detectors to the peak time delay of the cross correlation function.

### Single Laser Beam

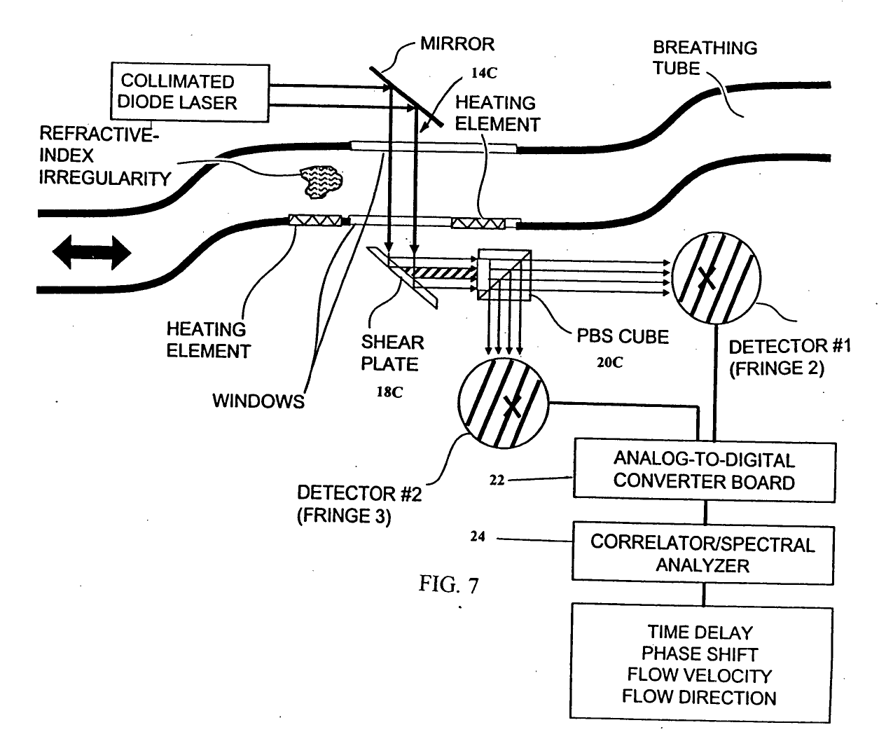

FIG. 7 shows another preferred embodiment of the present invention. In this case only one laser beam from laser diode 8A passes through the flowing fluid. The single beam 14C is collimated and passed through the flowing fluid. A single shear plate 18C is used to produce a large number of fringes. The interfered beam is split into two parts by polarizing beam splitter cube 18D and separate fringes are monitored by detector 20A and detector 20B, each detector looking at only one fringe. The two monitored fringes are chosen so that they are representative of separate portions of beam 14C, one portion being displaced from the other a measurable amount in the direction of flow. Based on the measurements of fringe intensity flow rates are determined as described above.

### Use of Photo Diode Array Detector

In another preferred embodiment a 1024-pixel photo diode array replaces the beam splitter and the two detectors. The photo diode array will preferably be positioned such that about 4 to 7 pixels cover each fringe. One or more pixels could then be used to monitor two spaced apart fringes as the flow is varied in and our. Correlation can be made either manually as described above or with the cross-correlation algorithm as described above.

### Two Types of Flow Measurements for Each Breath

FIG. 8 are oscilloscope charts of two intensity of two fringes during the first 0.2 second of respirator flow during a breathing cycle. Note that during the first part of the cycle there is good correlation between the two charts. Also note that during the last 50 ms on the charts correlation is poor. However, Applicant has determined that during this last portion the variations of the signals from the fringe intensity values are proportional to the flow velocity. Therefore, in a preferred embodiment, two different techniques are used to measure flow. During the first part of the cycle correlations are made as described above using the two sets of fringe data and correlating them to obtain the flow rate and direction. During the latter part of the breathing cycle each of the sets of fringe data are analyzed separately. The data are first smoothed such as by making running averages of about 5 intensity values. The average values are then normalized and the average is subtracted from each normalized value and the results plotted. The numbers of zero crossings are then counted and the flow rate is estimated based on the number of zero crossing. Applicant has determined that there is good correlation between the numbers of zero crossings counted and the flow rate during the later part of the breathing cycle.

### Embodiments Based on Droplet Scattering

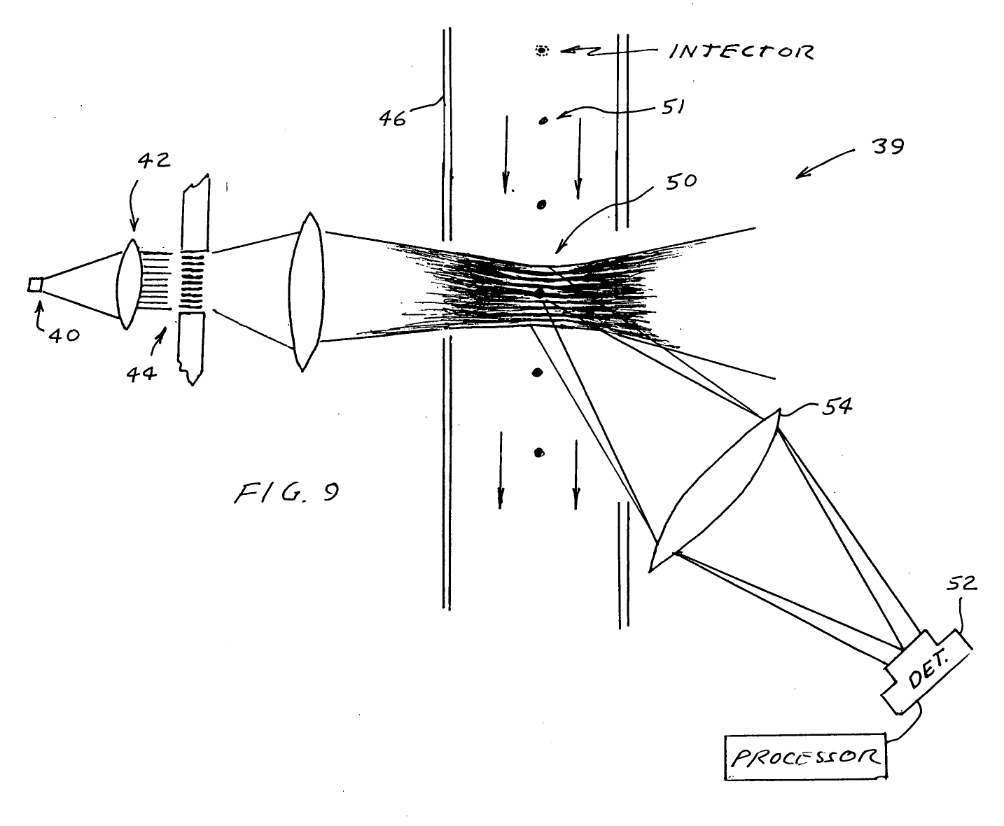

Another preferred embodiment, described by reference to FIG. 9 is based on the droplet scatter effect. It uses a periodic intensity pattern formed by a grating illuminated by an incoherent source (LED) and imaged into the flow in conjunction with a light scatter by water droplets to measure the temporal frequency of the scattered light.

A light beam illuminates a grating and forms a periodic intensity pattern with the spatial period, S, and is imaged into the measuring volume within the air flow. Water droplets having 20-60 microns diameter are ejected into the air flow within the measurement volume. Light scattered from particles in the flow is collected and processed. Particles moving through the measuring volume scatter light of varying intensity, some of which is collected by a photodetector. The resulting frequency of the photodetector output is related directly to particle velocity. The time varying sensor response is processed by using the Fast Fourier Transform (FFT) algorithm, and from the frequency of the sensor output the flow velocity is determined.

The temporal period of the sensor response relates to the spatial period of the grating, S, and flow velocity by the equation

$$T = \frac{S}{V} . \qquad ( 1 )$$

Consequently, the signal frequency is given by f=V/S, and

V=f×S. (2)

Once the signal frequency is estimated using the FFT, the flow velocity is determined from Eq. (2) since the spatial period of the grating is known.

### Particle Ejection

Ejecting particles into the air flow is straightforward using today's inkjet printer technology. Inkjet cartridges are designed to create droplets on the order of 20-50 microns, and eject them at high repetition rates (10 kHz). And, inkjet cartridges are very cheap ($20-30). An excellent reference on this technology is the book Microdrop Generation by Eric R. Lee (CRC Press, 2003).

There are two main technologies for droplet ejection: piezoelectric, and thermal bubble-jet. In the former piezoelectric crystals compress the fluid in a capillary tube and cause a droplet to be ejected out of the open end of the tube. (This technology is used in Epson inkjet printers.) In the thermal case a small heating element rapidly boils the liquid in a capillary tube and forces the ejection of a droplet. The hot gas quickly cools down and returns to the liquid state, ready for the next droplet ejection. (This technology is used in HP and Cannon printers.)

For our laboratory tests we chose a piezoelectric injector from Microfab Technologies (Model MJ-AB-01-60). This is designed to inject droplets of 60 microns in diameter. We chose the 60 micron diameter droplets to provide the largest scattered signal at the detector. Our tests revealed that for the breathing applications and flow measurements within a 15×15 mm² measurement cuvette the droplet diameter can be reduced to 20 microns. A smaller particle diameter, as it is shown below, reduces the relaxation time constant and improves the sensor performance, as well as reduces the total amount of water and the impact on the relative humidity. We recommend the use of the 20 micron droplets in the commercial sensor prototype.

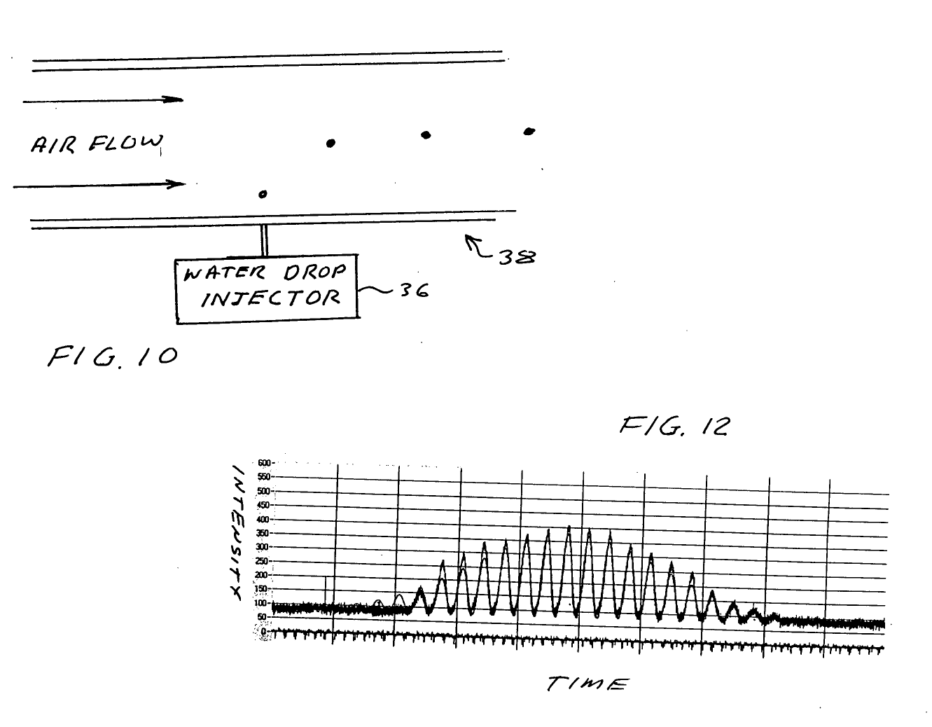

FIG. 9 shows a optical flow monitor system 39. It includes light source 40, collimated by collimating lens 42, illuminates ten 50 micron wide slots spaced at 100 micron intervals in grating 44. The grating pattern is imaged at the center of respirator tube 46 by lens 48 producing ten illumination fringes at the center of the tube as shown at 50. Water droplets 51 are injected at the rate of about 10 Hz or 20 Hz from the bottom of the tube into the flow of respirator air as shown in FIG. 10. Light defracted from the droplets as they pass through the illumination pattern with a spatial period of 102 microns shown at 50 is focused onto detector 52 by lens 54 to produce a periodic intensity at the output of detector 52. The spatial period of the illumination pattern is preferably chosen so that the spatial period of the illumination pattern is about twice the size of the droplet diameter. Collimating lens 42 could be chosen to magnify the grating pattern to produce the desired illumination pattern. For Applicants demonstration, a spatial period of 102 microns was established equivalent to a spatial frequency of about 98 cm⁻¹. The output of detector 52 is analyzed by processor 56 in order to determine the measured temporal frequency, preferably by converting intensity vs. time data from detector 52 to temporal frequency values using a Fast Fourier Transform (FFT) program. Since the spatial frequency is known, the velocity of the droplets is determined by the ratio of the temporal frequency to the spatial frequency. For example, a spatial frequency of 98 cm⁻¹ and a measured temporal frequency of 200 Hz would imply a droplet velocity of about 2.04 cm/s (about 122 cm/minute) and since the flow cross section is about 2.25 cm² the flow rate would be about 0.276 liters/minute.

### Optical Set Up

A demonstration setup can be explained by reference to FIGS. 9 and 10. Droplets were injected by injector 36 into the measurement cuvette from the bottom and rose up into the fringe pattern as shown in FIG. 10. Light scattered in the forward direction from the droplets was captured by a 1 inch diameter lens 38 positioned approx. 45 degrees off-axis. This lens imaged the light from the droplets onto a detector with a 1:1 imaging ratio. The detector was a 3 mm diameter silicon photodiode biased in the photoconductive mode with 18 v to increase the response time.

### Flow Direction

The setup shown in FIG. 9 “sees” all of the fringes simultaneously so that its time response contains no information about flow direction. It contains information exclusively about intensity and time (and temporal frequency) that is related to flow rate. In order to determine direction, a separate detector setup can be included as shown in FIG. 11 where both “in” and “out” monitors would use the same injector but a second set of illumination and detection equipment would be provided as shown at 60 in FIG. 11. Optical components 39 monitor the out flow 62 and optical components 60 monitor in-flow 64.

An alternative technique for determining flow direction is to use two separate injectors positioned on each side of the illumination fringes. It is also possible to position the injector at the center of the fringes and substitute a detector array for detector 52. In this later case, the region may need to be expanded or separated into two sets of fringes all preferably within the field of view of at least one of the detectors in the detector array.

A multi-detector scheme would provide an additional benefit in that it would permit an increase in the droplet ejection rate and thus an increase in the sampling rate and flow velocity update rate. The latter is due to the following. In a single-detector scheme, the droplet ejection rate is limited by the requirement that the scattered signals from two, or more, droplets do not overlap on the detector, because the overlap will create signal interference and will make frequency determination using an FFT difficult. This limits the ejection rate especially at low flow rates because the next droplet cannot be ejected prior to the current one passing all the fringes.

In a multi-detector scheme, if an array consists of M detectors, then the droplet ejection rate can be increased by a factor M, because each detector acquires the light scattered from only few fringes. Thus, the proposed detector array will provide simultaneous measurements of both the flow rate and flow direction, as well as increase the sampling rate and flow velocity update rate up to 100-200 Hz.

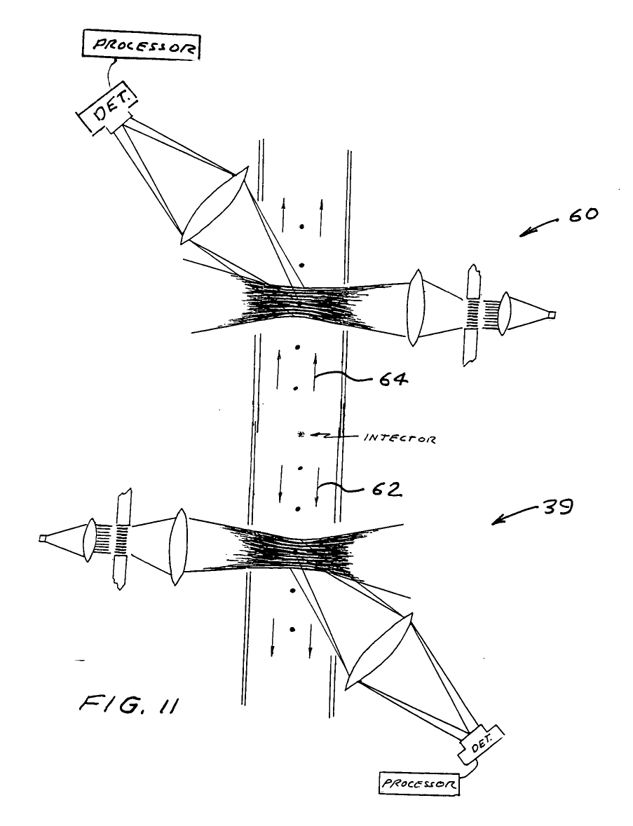

As an alternative to the FFT analysis, the intensity vs. time data could be analyzed by a least-square fit of the sinusoid with given period to the sensor response. FIG. 12 is an example of raw signal of the droplet flow sensor and a sinusoidal fit using a least-square routine. In this demonstration, scatter from about 17 fringes were detected to indicate a flow rate of about 0.67 liters/minute.

Simple analysis shows that the tiny water droplets are harmless. Indeed, if the droplet diameter is 60 μm, and droplets are ejected at a rate of 100 Hz, then during one second the volume of water of a 11.4 10⁻⁹ liter/sec is ejected. At the lowest flow rate expected of 0.1 l/min, and temperature in the range from 10 to 30 degree C. the change of the relative humidity caused by 60 μm droplets injection is about 10%, and it is less for higher flow rates. Consequently, for 20 μm droplets selected for the commercial sensor prototype the relative humidity change is 1%. Thus the impact of the droplet ejection on the relative humidity of the air in the patient airway is negligibly small.

If an ejector operates continuously during 1 year, or 31.1×10⁶ sec, then the total volume of water is 340 milliliter/year. If the droplet diameter is 20 μm, then the total volume of water is 38 milliliter/year or about 0.07 microliters per minute.

### Experimental Demonstration

Experimental demonstration was performed in a laboratory setting in two regimes: a) constant one-dimensional air flow, and b) pulsed one-dimensional flow that simulates a human breath generated by the Siemens gas module. In the demonstration the Doppler optical flow sensor was tested against commercial TSI hot-wire anemometer. Two modification of the measurement scheme were made. One, the LED was replaced with a He—Ne laser because this laser was available in house. And, two a single detector was used in the test because the Siemens gas module generates exclusively a one-dimensional air flow.

The sensor was tested when the flow rates ranged from 100 l/min down to 0.09 l/min in steps of ½ (100, 50, 25, 13.3, 5.33, 2.67, 1.33, 0.67, 0.33, 0.17, 0.09). The droplets were ejected at a rate of 20 Hz, except for the lowest 3 flow rates where the rate was reduced to 10 Hz to keep the droplets from overlapping on the detector.

The key observations from these experiments are first, the dynamic range of this demonstration optical flow monitor from 0.09/min up to 100 l/min. Second, the amplitude of the temporal signal variations from the Doppler sensor is independent of the flow rate. This is because these temporal signal variations are created by the motion of the droplet through a periodic intensity pattern. Consequently, the depth of the signal modulation stays the same, only the frequency of the sensor response changes with the flow rate. This is an important property of the monitor since it permits an exceptionally large dynamic range.

While the above description contains many specifications, the reader should not construe these as a limitation on the scope of the invention, but merely as exemplifications of preferred embodiments thereof. For example, the present invention could be applied for many other applications other than respirators. These include industrial applications where gas flow monitoring is important. Also, the present invention could be applied to monitor liquid as well as gas flow. Many medical applications require monitoring of respiratory gases in breathing circuits. Measurements of flow rate in combination with gas concentration measurements are useful for variety of diagnostic procedures, titration treatment, calculations of consumption parameters, patient safety monitoring, as well as monitoring high end and military breathing systems. Respiratory monitoring in needed in particular, to provide alarms that alert the patient's attendants to a significant change in condition in order to insure the timely implementation of lifesaving measures. Accurate flow sensors are used in diagnostic settings in association with other measurements (breath rate, gas concentrations, heart rate, temperature) to calculate various pulmonary and cardiac function parameters. The main requirements of the respiratory monitoring systems from the primary users are performance, including measurement accuracy, operating range, repeatability, convenience, reliability, easy cleaning, low maintenance and low cost.

Accordingly the reader is requested to determine the scope of the invention by the appended claims and their legal equivalents, and not by the examples given above.

What is claimed is:

1. A device for measuring fluid flow of flowing fluid comprising:
A) a disturbance means for producing disturbances in the flow without obstructing said fluid flow,
B) an optical unit for producing a light beam directed through said flowing fluid,
C) a detector for monitoring at least a portion of said light beam after said light beam exits said flowing fluid,
D) a processor for calculating flow values based on signals from said detector.

2. The device as in claim 1 wherein said disturbance means comprises a heating unit.

3. The device as in claim 1 wherein said disturbance means comprises a droplet injector.

4. The device as in claim 1 wherein said flowing fluid is breathing air flowing through a respirator tube.

5. The device as in claim 3 wherein said droplet injector is a water droplet injector.

6. The device as in claim 5 wherein said optical unit comprises a pattern producing unit for producing an optical pattern in said flowing fluid.

7. The device as in claim 5 wherein said optical unit comprises a lens grating for producing a spatially periodic pattern in said flowing fluid.

8. The device The device as in claim 7 and further comprising a lens for focusing onto said detector light reflected or defracted from water droplets as said droplets pass through said spatially periodic pattern.

9. The device as in claim 8 wherein said processor is programmed with an algorithm for converting time varying signals from said detector into temporal frequency information.

10. The device as in claim 9 wherein said algorithm includes provisions for performing Fast Fourier Transform.

11. The device as in claim 9 wherein said processor is also programmed with an algorithm for determining fluid flow rates using said temporal frequency information and spatial frequency information corresponding to said spatially periodic pattern.

12. The device as in claim 5 wherein said detector is a detector array.

13. A device for measuring flow of a fluid comprising:
A) a laser and laser optics configured to direct laser beams produced by said laser through a flowing fluid to produce a flow perturbed laser beam,
B) an interference producing means for producing interference patterns in said flow perturbed laser beam,
C) two optical detectors defining a first detector configured to monitor at least one interference fringe defining a first interference fringe and a second detector configured to monitor at least one interference fringe other than said first interference fringe,
D) a correlation means comprising a computer processor for correlating data from said first and second detectors to determine flow rate of said fluid.

14. A device as in claim 13 wherein said laser optics define a beam crossing location where said beam passes through said flowing fluid and further comprising at least one heating element configured to heat said fluid upstream of said crossing location.

15. A device as in claim 14 wherein said fluid flow is alternately in opposite directions, defining a forward direction and a reverse direction, wherein said at least one heating element is two heating elements, one located upstream of said crossing location with flow in the forward direction and the other located upstream with flow in the reverse direction.

16. A device as in claim 13 wherein said correlation means comprises an oscilloscope for comparing fringe data.

17. A device as in claim 13 wherein said correlation means comprises analog to digital converter and a digital processor programmed to perform cross-correlation analysis to compare fringe data and to calculate flow velocity and direction from results of said cross correlations.

18. A device as in claim 13 wherein said correlation means comprises analog to digital converter and a digital processor programmed to perform cross-spectral analysis to compare fringe data and to calculate flow velocity and direction from results of said cross spectrum.

19. A device as in claim 13 wherein said correlation means comprises analog to digital converter and a digital processor programmed to perform cross-correlation analyses to compare low frequency fringe data to calculate flow velocity and direction from results of said cross-correlation for the onset of the flow and to perform running average and compute the number of zero crossing points per interval for high frequency fringe data to calculate the flow rate for the subsequent portion of the breathing cycle.

20. A device as in claim 13 wherein said device is configured to monitor flow of a respirator.

21. A method of monitoring flow of a fluid comprising the following steps:
A) producing optical perturbations in said flow at a first location,
B) transmitting a laser beam through said flow downstream of said first location to produce a perturbed laser beam,
C) measuring perturbations in at least two separate portions of said perturbed laser with at least two detectors, and
D) comparing information from said at least two detectors to determine said flow.

22. A method as in claim 21 wherein an oscilloscope is utilized to compare said information from said two detectors.

23. A method as in claim 21 wherein said information from said two detectors are compared using an analog to digital converter and a digital processor configured with an algorithm to perform cross correlations.

24. A method as in claim 21 wherein said information from said two detectors are compared using an analog to digital converter and a digital processor configured with an algorithm to perform cross spectral analysis.

25. A method as in claim 21 wherein said information from said two detector are compared using an analog to digital converter and a digital processor is configured with an algorithm to perform cross correlation analysis to determine the flow velocity and flow direction at the onset of the flow during a portion of a breathing cycle and, during a subsequent portion of the breathing cycle to smooth the signal fluctuations in each array of said values by performing running averages of 4-8 values and to compute the number of zero crossing points during selected time intervals to calculate flow rate for the subsequent portion of the breathing cycle.

26. A device for measuring gas flow in a respirator tube comprising a flowing gas:
A) a tube section having a transparent section to permit the passage of light through said flowing gas,
B) optical elements for producing a spatially periodic pattern in said flowing gas
C) a water drop injector for injecting water droplets into said flowing gas,
D) a detector,
E) a focusing element for focusing light reflected or refracted from said water droplets onto said detector as said water droplets pass through said spatially periodic pattern,
F) a processor for converting signals from said detector into fluid flow information.
